(19) United States
(12) Patent Application Publication
(10) Pub. No.: US 2017/0023282 A1
(43) Pub. Date: Jan. 26, 2017

(54) USER-CONTROLLED ICEMAKER SYSTEM

(71) Applicant: HAIER AMERICA RESEARCH AND DEVELOPMENT CO., LTD., Camden, SC (US)

(72) Inventor: Jerry Richard BAACK, Lugoff, SC (US)

(21) Appl. No.: 14/804,854

(22) Filed: Jul. 21, 2015

(51) Int. Cl. F25C 1/04; H01H 13/14; H01R 13/66

(52) U.S. Cl. CPC F25C 1/04; H01R 13/6641; H01H 13/14

(57) ABSTRACT

An icemaker system with user control includes a wiring harness, an icemaker having a connector for the wiring harness, a user interface, a controller connected to the wiring harness, and an adapter connecting the user interface to the wiring harness that connects the user interface to the controller through a rotation sensor supply line on the wiring harness.

### BACKGROUND

Many consumer-grade freezers are equipped with icemakers. Conventional icemakers produce crescent-shaped ice cubes in a mold and scoop them into a bin. This cycle is continually repeated until a bale arm on the icemaker is lifted by ice in the bin when the bin is filled. At this point, ice production is halted to prevent the freezer from being filled with ice. The conventional crescent icemakers use a heater in the mold to separate the ice from the mold after freezing, which represents an energy expenditure.

The United States Department of Energy has imposed new energy regulations on icemakers. This has resulted in wide adoption of twist tray style icemakers. In these systems, a tray resembling a manual ice tray is mounted over a bin and twisted in place by a user or a motor. This twisting releases the ice and deposits it in the bin without using a heater, resulting in less energy used.

Modern refrigerators and freezers have integrated computer systems that control the components of the refrigerator/freezer. As a result, modern refrigerator/freezers have a wiring harness to interconnect the various components. This wiring harness and all of the components connected thereto (including the icemakers) have 6 pins as standard. The onboard computer in the refrigerator/freezer controls the icemaker through this 6-pin wiring harness.

### SUMMARY

A problem arises when user control over the icemaker is added to the exterior or other user accessible area of the refrigerator/freezer. The wiring harness is conventionally 6-pin and is usually integrated into the cabinet with foam early in the manufacturing process. This 6-pin harness does not have space for a user control signal for the icebox. Therefore, in order to implement user control over the icemaker, an additional harness would need to be retrofitted at significant additional cost.

In view of the above, exemplary embodiments of the broad inventive concepts described herein provide an icemaker system with user control including a wiring harness, an icemaker having a connector for the wiring harness, a user interface, a controller connected to the wiring harness, and an adapter connecting the user interface to the wiring harness that connects the user interface to the controller through a rotation sensor supply line on the wiring harness.

In some embodiments, the adapter connects a tray motor power line on the wiring harness to a rotation sensor supply line on the icemaker connector. In some embodiments, the adapter connects a forward tray motor power line and a reverse tray motor power line on the wiring harness to a rotation sensor supply line on the icemaker connector. In some embodiments, the connections between the tray motor power lines to the rotation sensor supply line on the icemaker connector are made through diodes. In some embodiments, the user interface is a power on/off switch for the icemaker. In some embodiments, the user interface is a single-pole double-throw switch. In some embodiments, the adapter is connected between the wiring harness and the icemaker connector. In some embodiments, the system further includes a signal conditioner that connects the wiring harness to the controller. In some embodiments, the signal conditioner includes a voltage divider.

Exemplary embodiments provide an adapter for connecting a freezer wiring harness to an icemaker and connecting a user interface including a first connection that is configured to deliver electrical power from a first tray motor supply line on the wiring harness to a tray sensor supply line on the icemaker, and an interface connection that is configured to connect the user interface to a tray sensor supply line on the wiring harness.

In some embodiments, the adapter further includes a second connection that is configured to deliver electrical power from a second tray motor supply line on the wiring harness to the tray sensor supply line on the icemaker. In some embodiments, one of the first and second tray motor supply lines is a forward rotation supply line and the other is a reverse rotation supply line. In some embodiments, the first and second connections comprise diodes.

### BRIEF DESCRIPTION OF THE DRAWINGS

FIG. 1 is a block diagram of an icemaker system according to one embodiment.

FIG. 2 is a partially cut-away perspective view of a freezer/refrigerator incorporating the icemaker system according to the embodiment of FIG. 1.

FIG. 3 is a schematic diagram of an adapter for use in the embodiment of FIG. 1.

### DETAILED DESCRIPTION OF THE EMBODIMENTS

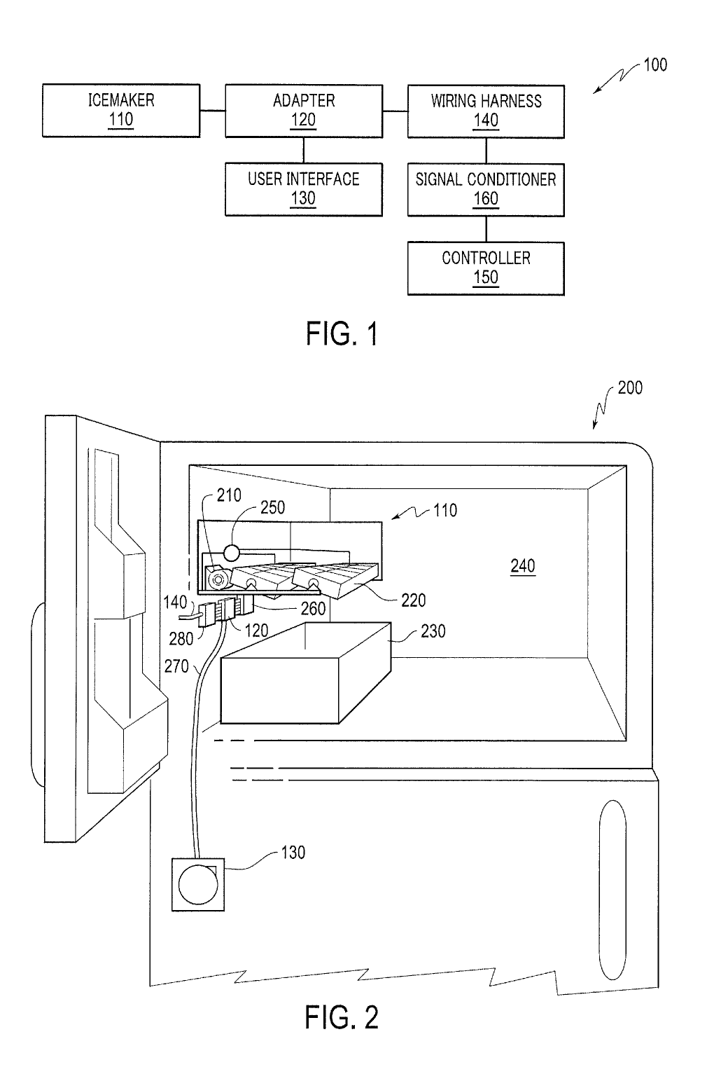

FIG. 1 shows a block diagram of a system 100 according to one embodiment. In system 100, icemaker 110 is connected to controller 150 by wiring harness 140. Controller 150 controls the operations of icemaker 110. Adapter 120 connects user interface 130 to controller 150 through wiring harness 140. In this embodiment, adapter 120 is connected between wiring harness 140 and icemaker 110; however, in other embodiments adapter 120 is connected between wiring harness 140 and signal conditioner 160. Without adapter 120 and user interface 130, icemaker 110 would operate in an automated fashion perpetually making ice until it detects a full bin. User interface 130 is a power on/off switch in this embodiment. This allows a user to directly turn icemaker 110 on and off In some embodiments, user interface 130 will be located on an exterior of a freezer or refrigerator/freezer containing icemaker 110. Adapter 120 allows for the retrofitting of user interface 130 while using a standard 6-pin wiring harness 140.

Controller 150 may include a processor, CPU, microcontroller executing software, or a fully programmable gate array. Controller 150 may further include memory such as RAM, ROM, or flash memory, and storage such as a hard disk drive or flash storage.

FIG. 2 shows a freezer 240 as part of a freezer/refrigerator combination 200 incorporating icemaker system 100. In this embodiment, a twist tray style icemaker 110 is being used. Accordingly, icemaker 110 includes trays 220 that are twisted by motor 210 to freeze and dispense ice into bin 230. When there is an obstruction in the twisting motion of trays 220, sensor 250 produces a signal. Controller 150 determines if trays 220 are fully twisted, in a home position, or if bin 230 is full based on the presence of the signal from sensor 250 and other contextual information about the state of icemaker 110. In a twist tray icemaker, a single switch or sensor 250 is used to indicate a full bin condition, a tray home condition, and a tray twisted condition.

Normally, icemaker 110 is connected to controller 150 via a 6-pin wiring harness 140, and icemaker connector 260 is plugged into wiring harness connector 280. The 6 pins on wiring harness 140 include:
Pin 1—Tray Motor 210 Power (Forward)
Pin 2—Tray Motor 210 Power (Reverse)
Pin 3—Temperature Sensor Supply
Pin 4—Rotation Sensor 250 Return
Pin 5—Rotation Sensor 250 Supply
Pin 6—Temperature Sensor Ground

This arrangement of pins on wiring harness 140 leaves no room for external control of icemaker 110. However, it is desirable to include an on/off switch or other user control via a user interface 130 on the exterior of refrigerator/freezer 200. In order to accomplish this, the functionality of the pins on wiring harness 140 is modified. This modification is accomplished in several embodiments using adapter 120, which is connected between icemaker connector 260 and wiring harness connector 280 in the embodiment shown in FIG. 2. Adapter 120 is connected to wire 270 connected to user interface 130 on the exterior of the refrigerator/freezer 200.

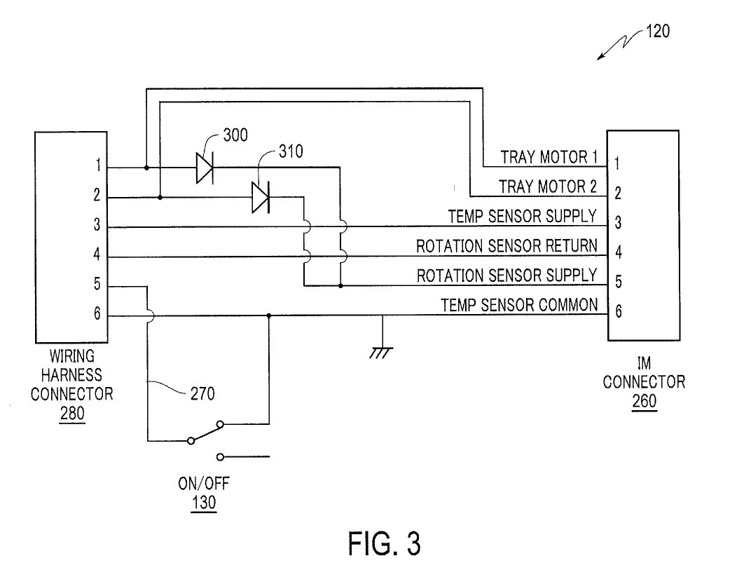

Signals from rotation sensor 250 are only needed at times when motor 210 is being powered, because rotation sensor 250 detects obstruction in the twisting motion of trays 220. Adapter 120 exploits this in order to free pin 5 (the rotation sensor 250 power supply) for conveying user interface 130 signals to controller 150 via wire 270. In order to do this, power to the rotation sensor 250 is provided by tapping power from pins 1 and 2 that power motor 210 when trays 220 are being twisted. This is accomplished using adapter 120, as shown in FIG. 3, which is a schematic of adapter 120 according to several embodiments. Sensory information from rotation sensor 250 may be needed during either forward or reverse motion of trays 220. Therefore, sensor 250 is powered by both the forward and reverse power lines of motor 210. Accordingly, the switch supply to icemaker connector 260 is connected to both forward and reverse power lines. In order to prevent a short circuit, diodes 300 and 310 are in the current path between the motor power lines and the switch supply. In some embodiments diodes 300 and 310 are 1N4148's. Diodes 300 and 310 ensure that a positive voltage is applied to sensor 250 when motor 210 is rotated in either a forward or reverse direction.

With pin 5 on wiring harness 140 now available for use, it is connected to user interface 130 via wire 270. In the embodiments shown, user interface 130 is a power on/off switch. In some embodiments, user interface 130 is a single-pole, double-throw switch. In this embodiment, grounding wiring harness pin 5 is interpreted as icemaker 110 being “off” by controller 150. Controller 150 can accordingly cease powering motor 210 and take any other needed action to ensure no ice is made, such as turning off the water supply to icemaker 110. Harness pin 5 is grounded when on/off switch is in a condition connecting harness pin 5 and wire 270 to wiring harness pin 6, which is connected to ground. Allowing wiring harness pin 5 to float is interpreted as an “on” state.

Adapter 120 changes the voltage levels of the signal from rotation sensor 250, because motor power lines are 0-12 VDC in this embodiment, whereas controller 150 is designed for a signal of 0-5 VDC. Therefore, signal conditioner 160 is connected between wiring harness 140 and controller 150. Signal conditioner 160 may include a voltage divider that converts the 0-12 VDC signal to 0-5VDC. Moreover, since floating wiring harness pin 5 results in an “on” condition, a voltage divider or pull-up circuit may be included in signal conditioner 160 and connected to wiring harness pin 5.

The software executing on controller 150 that controls icemaker 110 is modified in some embodiments due to the rotation sensor 250 only being powered during when the tray motor 210 is activated. In several embodiments rotation sensor 250 is a switch that is closed when the tray is stopped or reaches a home or fully twisted condition. Normally, controller 150 can determine if the tray is in a partially twisted condition at any time by instantaneously determining if sensor 250 is open or closed. However, in the embodiments herein sensor 250 is not powered when tray motor 210 is not activated and trays 220 are not rotating. During these periods, switch 250 will appear open, even if trays 220 are not fully twisted, home, or obstructed by ice in bin 230. Accordingly controller 150 activates motor 210 to obtain a useable signal from sensor 250 or checks the status of sensor 250 before stopping motor 210. Controller 150 subsequently stores the state of sensor 250 during rotation in memory. Accordingly, controller 150 can obtain information about state of the trays 220 from sensor 250 while motor 210 is activated, and retain that information when motor 210 is stopped.

Although the invention has been described with reference to embodiments herein, those embodiments do not limit the scope of the invention. Modifications to those embodiments or different embodiments may fall within the scope of the invention.

What is claimed is:

1. An icemaker system with user control, comprising:
a wiring harness;
an icemaker having a connector for the wiring harness;
a user interface;
a controller connected to the wiring harness; and
an adapter connecting the user interface to the wiring harness that connects the user interface to the controller through a rotation sensor supply line on the wiring harness.

2. The system of claim 1, wherein the adapter connects a tray motor power line on the wiring harness to a rotation sensor supply line on the icemaker connector.

3. The system of claim 2, wherein the adapter connects a forward tray motor power line and a reverse tray motor power line on the wiring harness to a rotation sensor supply line on the icemaker connector.

4. The system of claim 3, wherein the connections between the tray motor power lines to the rotation sensor supply line on the icemaker connector are made through diodes.

5. The system of claim 1, wherein the user interface is a power on/off switch for the icemaker.

6. The system of claim 1, wherein the user interface is a single-pole double-throw switch.

7. The system of claim 1, wherein the adapter is connected between the wiring harness and the icemaker connector.

8. The system of claim 1, further comprising:
a signal conditioner that connects the wiring harness to the controller.

9. The system of claim 8, wherein the signal conditioner includes a voltage divider.

10. An adapter for connecting a freezer wiring harness to an icemaker and connecting a user interface, comprising:
a first connection that is configured to deliver electrical power from a first tray motor supply line on the wiring harness to a tray sensor supply line on the icemaker; and
an interface connection that is configured to connect the user interface to a tray sensor supply line on the wiring harness.

11. The adapter of claim 10, further comprising:
a second connection that is configured to deliver electrical power from a second tray motor supply line on the wiring harness to the tray sensor supply line on the icemaker.

12. The adapter of claim 11, wherein one of the first and second tray motor supply lines is a forward rotation supply line and the other is a reverse rotation supply line.

13. The adapter of claim 12, wherein the first and second connections comprise diodes.
